(19) United States
(12) Patent Application Publication
(10) Pub. No.: US 2019/0031819 A1
(43) Pub. Date: Jan. 31, 2019

(54) Heat-curing Two-component Epoxide Resin

(71) Applicant: Dr. Neidlinger Holding GmbH, Ostfildern-Kemnat (DE)

(72) Inventors: Max Poxleitner, Ostfildern (DE); Peter Graeter, Filderstadt (DE)

(21) Appl. No.: 16/146,888

(22) Filed: Sep. 28, 2018

Related U.S. Application Data
(63) Continuation of application No. PCT/EP2017/057452, filed on Mar. 29, 2017.

(30) Foreign Application Priority Data
Apr. 1, 2016 (DE) 102016106031.3

(51) Int. Cl. C08G 59/68; C09K 5/14; C08G 59/40

(52) U.S. Cl. CPC C08G 59/68; C08G 59/40; C09K 5/14

(57) ABSTRACT

The present invention relates to a heat-curing two-component epoxide resin system which comprises the following ingredients: a first component with an epoxide resin; and a second component which is separately present from the first component, characterized in that the second component comprises a homopolymerization catalyst and a reactive diluent.

### CROSS-REFERENCES TO RELATED APPLICATIONS

This application is a continuation of co-pending International Patent Application PCT/EP2017/057452 filed on 29 Mar. 2017, and designating the United States of America, which was not published under PCT Article 21(2) in English, and claims priority of German Patent Application DE 10 2016 106 031.3 filed on 1 Apr. 2016. The entire contents of these prior applications are incorporated herein by reference.

### FIELD

The present invention relates to epoxide-based polymeric compositions. In particular, the present invention relates to a heat-curing two-component epoxide resin system.

### BACKGROUND

State of the art epoxide resins, for example bisphenol resins, are widely used in the form of sealing resins and adhesives, such as heat-curing one-component/two-component sealing resins or adhesives and room temperature-curing two-component sealing resins or adhesives, respectively. Furthermore, oxide resins are widely used as resin components of composite materials, in particular fiber composite materials, in coatings and as sealing compounds, for example to seal electronic components.

Heat-curing two-component epoxide resins based on acid anhydride curing agents are frequently used as insulating materials and/or adhesives in the field of low voltage, medium voltage and high voltage technology due to their good impregnation properties.

DE 38 24 251 discloses an insulating tape for the manufacture of an insulating sleeve for an electrical conductor impregnated with a heat-curing epoxide resin acid anhydride mixture. For example, the epoxide resin acid anhydride mixture comprises a glycidyl ether of bisphenol A and methylhexahydrophthalic acid anhydride.

US 2014/287173 discloses a reactive hot melt adhesive with two separately present components. The first component may contain polymers having epoxide functional groups and the second component may contain acid anhydrides, such as maleic acid anhydride.

U.S. Pat. No. 5,574,112 discloses a coating process using a mixture of an epoxide group-containing synthetic resin, a cross linker and a polyol. A cross linker comprises a compound having at least two carboxyl groups and at least one acid anhydride group per molecule.

US 2003/071368 discloses epoxide resin compositions comprising a cycloaliphatic epoxide resin, hexahydro-4-methylphthalic acid anhydride as a curing agent, a boron-containing catalyst, and a curing rate modifying agent. The epoxide resin compositions are used in the manufacture of solid state devices such as LEDs.

Acid anhydrides have long been known for their respiratory sensitizing properties. Due to these properties, since December 2012, the cycloaliphatic acid anhydrides hexahydro-4-methylphthalic acid anhydride and cyclohexane-1,2-dicarboxylic anhydride have been included into the list of substances of very high concern (SVHC list) according to the REACH Regulation of the European Chemicals Agency (ECHA). Since almost all acid anhydride curing agents have respiratory sensitizing properties, this substance class may be banned from processing in the future.

### SUMMARY

Against this background, therefore, the object of the present invention is to provide an epoxide resin-based polymeric composition in which no acid anhydride is used as a curing agent. Another object of the present invention is to provide an epoxide resin-based polymeric composition in which basically no acid anhydrides are used. A further object of the present invention is to provide a heat-curing two-component epoxide resin system in which no components are used which have attained ECHA status as substances of very high concern. A further object of the present invention is to provide an epoxide resin system of the type mentioned above which is easy and safe to handle and has good storage stability.

This object is achieved by the heat-curing two-component epoxide resin system according to the invention. The heat-curing two-component epoxide resin system comprises the following components:
a first component comprising an epoxide resin; and
a second component being separately present from the first component, characterized in that the second component comprises a homopolymerization catalyst and a reactive diluent.

According to another aspect of the present invention, there is provided the use of such a heat-curing two-component epoxide resin system as a sealing resin, composite fiber component, corrosion inhibitor or adhesive.

Finally, the present invention provides a mixture for a heat-curing two-component epoxide resin system comprising the following:
a homopolymerization catalyst, and
a reactive diluent.

The present inventors have realized that epoxide resins undergo homopolymerization in the presence of certain catalysts. The difficulty with these one-component epoxide resins lies in their limited storage stability. The present invention is now based on providing the catalyst in a second component and thereby dissolving the catalyst in a reactive diluent and adding this second component to the first component only shortly before processing.

Surprisingly, it has been shown that a much improved storage stability can be achieved. Further advantages are the flexible mixing ratio of the two components, the variable properties of the second component via the amount of reactive diluent compared to the amount of homopolymerization catalyst, adaptable reactivity and the possibility to heat both components separately, since the polymerization reaction only takes place when both components are mixed and thus only shortly after the actual processing.

In the following, an “epoxide group” or “epoxide group” refers to a monosubstituted, disubstituted or trisubstituted oxirane/ethylene oxide of the general formula O(CHR₁)(CR₂R₃) where R₁, R₂ and R₃ can be identical or different residues.

Ethers of 2,3-epoxide-1-propanole (glycidole) and derivatives thereof are referred to as “glycidyl ethers” or “glycide ethers”, respectively.

The term “homopolymerization catalyst” as used herein refers to a catalyst which enables the defined catalysis of the epoxide group(s) of the used components above the storage temperature or room temperature, respectively. The homopolymerization catalyst itself does not become a component of the reaction product and thus has only a catalytic effect. A “homopolymerization catalyst” thus differs from a “curing agent” or a “cross linker”.

The homopolymerization catalyst is heat-curing and thus effects the polymerization only above room temperature and/or the storage temperature, for example beginning at a temperature of at least 50° C., preferably at least 55° C., at least 60° C., at least 65° C., at least 70° C., at least 75° C., at least 80° C., at least 85° C., at least 90° C., at least 95° C., at least 80° C., at least 100° C., at least 110° C., or at least 120° C. Suitable homopolymerisation catalysts are familiar to the person skilled in the art. In particular, suitable mixtures of a homopolymerization catalyst and a reactive diluent can be prepared and tested.

If necessary, the homopolymerization catalyst can also catalyze the reaction of other functionalities, i.e. functional groups of one or more compounds, with the one or more components of the system according to the invention. It is clear that this reaction of other functionalities also occurs at room temperature and/or storage temperature or at temperatures above room temperature and/or storage temperature. Preferably, the components of the heat-curing two-component epoxide resin system according to the invention and the mixture for a heat-curing two-component epoxide resin system are selected such that only the reaction of the epoxide group(s) is catalyzed.

The homopolymerization catalyst does essentially not react with the reactive diluent at room temperature and generally below the above-mentioned temperatures at which polymerization takes place. Thus, the component containing the homopolymerization catalyst and a reactive diluent can easily be stored for a period of at least one week, preferably at least two weeks, at least one month, at least two months, at least three months, at least four months, at least five months or at least six months, without affecting the reactivity with the component containing the epoxide resin.

The term “curing agent” or “hardener” as used herein refers to a chemical compound which effects the curing of an epoxide resin and/or reactive diluent. On the one hand, the curing agent effects the polymerization of epoxide resin and/or reactive diluent and, moreover, participates in the reaction in the manner of a cross linker. Polyamines and acid anhydrides are examples of curing agents. In addition to the homopolymerization catalyst, neither the reactive diluent, the epoxide resin nor any other component of the heat-curing two-component epoxide resin system according to the invention or the mixture for the heat-curing two-component epoxide resin system has a hardening property. For example, the reactive diluent contains no acid anhydride component. Thus, in the heat-curing two-component epoxide resin system according to the invention or the mixture for a two-component heat-curing epoxide resin system, a curing agent is not included.

The term “cross linker” as used herein refers to a chemical compound which effects only the cross linking in a polymerization reaction. The cross linker has no functional group that can cause polymerization of the epoxide resin and/or reactive diluent. Preferably, one or more cross linkers are present in the form of the reactive diluent. Examples of suitable cross linkers are glycidyl ethers having at least two, preferably three, four, six or eight epoxide groups.

The term “room temperature” or “ambient temperature”, as used herein refers to a temperature of 20° C. to 25° C., preferably 21° C. to 24° C., 22° C. to 23° C., more preferably 22° C.

The term “storage temperature” as used herein refers to the temperature at which the component containing the homopolymerization catalyst and a reactive diluent can be stored. The storage temperature is a temperature at which polymerization of the reactive diluent alone is essentially completely prevented. An essentially complete prevention of polymerization of the reactive diluent means, for example, that less than 1%, preferably less than 0.1%, of all functional groups present in the reactive diluent react within the storage period. Preferably the storage temperature corresponds to the room temperature. The storage temperature can also be below room temperature. This may, for example, be necessary when using reactive homopolymerization catalysts in order to essentially prevent their reaction with the reactive diluent at storage temperature.

The term “separately present” or “separate” refers in the context of the present heat-curing two-component epoxide resin system, to a spatial separation of the two components. Thus, the first component may be present in a first vessel and the second component in a second vessel.

In the present invention, polymerization of the epoxide resin system is effected exclusively by the homopolymerization catalyst. The catalyst is characterized by the fact that only the functional groups contained in the epoxide resin are catalyzed with one another, the reaction of the epoxide resin with the reactive diluent, and optionally, if a reactive diluent is also present in the first component, the reaction of this reactive diluent with a reactive diluent of the second component is catalyzed. The homopolymerization catalyst therefore preferably does not catalyze a reaction of further components which may be present in the first and/or the second components of the epoxide resin system.

The homopolymerization catalyst only catalyzes the reaction of the epoxide resin or reactive diluent, respectively, and does not itself participate in the cross linking which may take place and thus differs from a curing agent. As already mentioned, the cross linking is only provided by the epoxide resin and, if necessary, the reactive diluent. As a result, the homopolymerization catalyst does not include functional groups such as acid anhydride groups and/or multiple amine functionalities (especially polyfunctional amines) which can simultaneously act as polymerization catalyst and cross linker.

It is also clear that the homopolymerization catalyst is only present in the second component and that the reaction is only catalyzed by mixing the second component with the first component.

The homopolymerization catalyst preferably catalyzes only the reaction of an epoxide group. Alternatively, the reaction of an epoxide group with a hydroxyl group and/or amino group may also be catalyzed. It is clear that a suitable homopolymerization catalyst depends on the structure, especially the functional groups, the epoxide resin, the reactive diluent(s) and other optional components. The acid or base strength of the catalyst which is used as Lewis acid or Lewis base is of particular importance here.

The suitable acid or base strength can be described quantitatively using the HSAB principle. Hard and soft acids and bases (HSAB) are described on the basis of the Lewis definition of acids and bases. This can be taken from R. G. Pearson, Chem. Brit., Vol. 3 (1967), p. 103-107 and R. G. Pearson, J. Chem. Ed., Bd. 45 (1968), S. 581-587; R. G. Pearson, J. Chem. Ed., Bd. 45 (1968), S. 643-648, the contents of which are included herein by reference.

Examples of suitable homopolymerization catalysts without cross linking properties in Lewis acids, such as metal salts, including aluminum trichloride and boron trifluoride, and Lewis bases, such as trimeythylamine. The skilled person is familiar with suitable Lewis acids and Lewis bases. Particularly suitable homopolymerization catalysts include organic complexes of Lewis acids, such as trichloro(N,N-dimethyloctylamine)boron, which due to the organic component have a reduced reactivity vis-à-vis the corresponding Lewis acid, and in the case of trichloro(N,N-dimethyloctylamine) boron the stronger Lewis acid borontrichloride. Other such latent-reactive catalysts known in the state of the art may be used.

The present homopolymerization catalysts are preferably Lewis acids with an acid strength according to the HSAB principle which corresponds at least to that of a component of type BX₃(NR)₃, such as trichloro(N,N-dimethyloctylamine)boron. X may be a halide such as fluorine, chlorine, bromine or iodine. X is preferably fluorine or chlorine. It is clear that different residues X may be present in the compound of type BX₃(NR)₃. Examples of Lewis acids include BF₃, B(OR)₃, FeCl₃ and AlCl₃. Alternatively, the present homopolymerization catalysts are Lewis bases with a base strength according to the HSAB principle at least equal to that of NH(R)₂. Examples of such Lewis bases include R₃N. The before-mentioned residues R of compounds may be the same or different, include linear or branched alkyl, alkylene and alkynyl residues and have a molecular weight of the compound not exceeding 650 g/mol, preferably 600 g/mol, 500 g/mol, 400 g/mol, or 300 g/mol. R₃N may be for example N(CH₃)₃, N(CH₃)₂(C₂H₅) or N(CH₃)(C₂H₅)(C₂H₄).

Epoxide resins are either monomers or prepolymers (such as dimers, trimers, tetramers or mixtures thereof) containing on average two or more epoxide groups per molecule. The reaction of these epoxide resins with a variety of homopolymerization catalysts or curing agents known in the art, such as polyfunctional amines, results in cross linked or thermo-cured duroplasts.

The epoxide resin is usually only used in the first component and usually contains terminal epoxide groups as the reactive component. The same applies to the reactive diluent, which usually also contains only the epoxide groups which can undergo a reaction. However, the epoxide resin and/or the reactive diluent may have other functional groups which react only when both components are mixed and/or at a temperature equal to or above the polymerization temperature. Examples of these functional groups include hydroxyl groups. If more than one reactive diluent is used in a component, they are preferably of the same type, i.e. they include either only epoxide groups or epoxide groups and hydroxyl groups. The constituents of a given component do not react with each other at storage temperature.

The individual components can be heated independently from each other, which not only accelerates the polymerization process after mixing of the individual components, but also results in a better solubility and an improved end product of good homogeneity. For example, the second component can be heated to a temperature below the polymerization temperature, whereas the first component is not subject to such a restriction.

Examples of suitable epoxide resins include bisphenol-based epoxide resins such as bisphenol A, novolac epoxide resins such as phenol or cresole novolacs, aliphatic epoxide resins and halogenated epoxide resins and combinations thereof. Diglycidyl ethers of bisphenol A (DGEBA), bisphenol F and bisphenol A/F (The term A/F refers to a mixture of acetone with formaldehyde which is used as the starting material in its production) can be used. Such liquid resins are available as araldite (Huntsman) oder D.E.R (Dow) oder epicote (Hexion).

Other examples of bisphenol-based epoxide resins include bisphenol AF (available from phenol and hexafluoroacetone), bisphenol AP, bisphenol B, bisphenol BP, bisphenol C (available from o-cresole and acetone), bisphenol E, bisphenol F, bisphenol FL, bisphenol G, bisphenol M, bisphenol P, bisphenol PH, bisphenol S, bisphenol TMZ and bisphenol Z.

Glycidyl ethers in particular are used as reactive diluents. In particular, a distinction must be made between monofunctional glydidyl ethers and di- or polyfunctional glydidyle ethers. Although monofunctional glycidyl ethers react with the epoxide resin, no further cross linking takes place. As a result, monofunctional glycidyl ethers counteract cross linking, resulting in a rather soft malleable epoxide resin system. Polyfunctional glycidyl ethers, i.e. difunctional and especially glycidyl ethers with three or more epoxide functions, contribute to the spatial cross linking of the epoxide resins.

It is clear that both the type and the amount of glycidyl ether affect the degree of cross linking of the epoxide resin, and, as a result, the properties, in particular the strength, of the epoxide resin system can be influenced in a targeted manner. The reaction rate can also be specifically influenced by the type and quantity of glycidyl ether used. By influencing the mixing ratios of the components and/or the individual components with each other, the chemical and physical properties of the heat-curing two-component epoxide resin can be specifically influenced.

Examples of suitable glycidyl ethers include poly(tetramethyleneoxide)-diglycidyl ether, hexanediol diglycidyl ether, 2-ethyl-hexyl-glycidyl ether, polyoxypropylene glycol diglycidyl ether, trimethylolpropan-polyglycidyl ether, neopentylglycol-diglycidyl ether and 1,4-butanediol-diglycidyl ether. Preferred are poly(tetramethylene oxide)-diglycidyl ether, hexanediol diglycidyl ether and 1,4-butanediol-diglycidyl ether. Further suitable glycidyl ethers, as well as their presentation, are known to the skilled person.

An epoxide resin may also be used as a reactive diluent in the heat-curing two-component epoxide resin system and in the mixture for a heat-curing two-component epoxide resin system according to the invention, wherein this epoxide resin is not being allowed to polymerize in the presence of the homopolymerization catalysts. A homopolymerization catalyst and/or an epoxide resin with comparatively low reactivity can be used for this purpose. The skilled person can easily prepare suitable mixtures and visually monitor whether polymerization occurs in a given time period and/or a given temperature.

Reactive diluents are generally low-viscosity mono- or di-epoxides which participate chemically in the polymerization process. For example, glycidyl ethers of aliphatic and arylaliphatic mono- and polyalcohols, allyl and methallyl glycidyl ethers, phenyl glycidyl ethers and their alkylation products as well as products as well as certain epoxydized hydrocarbons such as styrine oxide, vinylcyclohexene dioxide, limonen dioxide, octene dioxide and epoxydized terpenes are used. Epoxide group-free reactive diluents include, for example, polymethoxyacetales or triphenylphosphite. Glycidyl ethers of aliphatic or arylaliphatic mono- and polyalcohols are preferred.

In the first component, based on 100 wt.-% of the first component, between 0 and 20 wt.-% of reactive diluents are used, preferably 1 to 19 wt.-% of reactive diluent, more preferred 5 to 18 wt.-% of reactive diluent, 6 to 17 wt.-% of reactive diluent, 7 to 16 wt.-% of reactive diluent, 8 to 15 wt.-% of reactive diluent, 9 to 14 wt.-% of reactive diluent, 10 to 13 wt.-% of reactive diluent or 11 to 12 wt.-% of reactive diluent.

In the second component, based on 100 wt.-% of the second component, preferably between 50 to 95 wt.-% of reactive diluent are used, such as 60 to 90 wt.-% of reactive diluent, 65 to 85 wt.-% of reactive diluent, more preferred 70 to 80 wt.-% of reactive diluent, 71 to 79 wt.-% of reactive diluent, 72 to 78 wt.-% of reactive diluent, 73 to 77 wt.-% of reactive diluent, 74 to 76 wt.-% of reactive diluent or 76 wt.-% of reactive diluent.

The optionally present reactive diluent of the first component and the reactive diluent of the second component may be independently selected from the above-mentioned reactive diluents.

The first component and/or second component may also contain ingredients such as thermally conductive particles, fillers, dyes, de-aerators and combinations thereof. Thermally conductive particles may include, for example, aluminum hydroxide or aluminum oxide. In terms of the polymerization reaction, fillers are chemical inert substances or compounds, i.e. compounds that do not participate in the polymerization reaction and do not dissolve in the heated mixture of the first component and/or the second component. Such fillers include, for example, particulate polymers with high melting temperatures. A preferred filler is quartz. Dyes can also be added to give the epoxide resin system a desired color. Dyes can be added in the form of a pigment paste. Siloxane can be used as a suitable de-aerator in the first component and/or the second component. Flame-retardant substances can also be incorporated into the first component and/or second component.

It is clear that, in addition to the first component and the second component, further components, for example a third component or a third and fourth component, may be present. One or more optional components, for example a reactive diluent or filler, may for example be present in another vessel and mixed simultaneously with the first component and the second component.

The term “comprise(s)” or “comprising” in the context of the present invention refers to an open enumeration and does not exclude other components or steps apart from those expressly mentioned.

The term “consist(s) of” or “consisting of” in the context of this invention refers to a complete list and excludes any other components or steps in addition to the expressly mentioned components or steps, respectively.

The expression “consist(s) essentially of” or “consisting essentially of” means, in the context of the present invention, a partially complete enumeration of designated compositions which, in addition to the above-mentioned components, contain only such other components which do not materially alter the character of the composition or which are present in quantities which do not materially alter the character of the composition.

In the context of the present invention, when a composition is described using the term “comprise(s)” or “comprising”, it expressly includes compositions consisting of or consisting essentially of said components.

It is understood that the above-mentioned features of the invention and those to be explained in the following cannot only be used in the particular combination given, but also in other combinations or in isolated manner, without departing from the scope of the invention.

Further features and advantages of the invention result from the following description of preferred embodiments and the FIGURE.

### BRIEF DESCRIPTION OF THE DRAWING

FIG. 1 shows the mixing viscosity of the epoxide resin system in comparison to the mixing viscosity of an acid anhydride-based epoxide resin system over time at 80° C.

### DESCRIPTION OF PREFERRED EMBODIMENTS

In an embodiment of the present invention, the epoxide resin is selected from the group consisting of bisphenol-based epoxide resin, a novolac epoxide resin, an aliphatic epoxide resin, a halogenated epoxide resin, and combinations thereof.

The afore-mentioned epoxide resins have in common that they comprise at least two epoxide groups, e.g. 3, 4, 5, 6, 7, 8, 9, 10 epoxide groups. Preferably, the epoxide resins comprise only two terminal epoxide groups. Optionally, two or more hydroxyl groups, such as 3, 4, 5, 6, 7, 8, 9, 10 or more hydroxyl groups, are included. In general, a higher number of epoxide groups and/or hydroxyl groups will result in an improved cross linking ability of the epoxide resin system and increased strength of the final product. It is clear that this effect can be further enhanced but also reduced by the choice of the reactive diluent(s).

In an embodiment the first component comprises a reactive diluent.

This reactive diluent may be selected from the above-mentioned reactive diluents and preferably comprises one or more glydidyl ethers selected from poly(tetramethylenoxide)-diglycidyl ether, hexanediol diglycidyl ether and 1,4-butanediol-diglycidyl ether. Alternatively, a reactive diluent containing hydroxyl groups and/or amino groups can also be used. Alternatively, an epoxide resin can be used as reactive diluent.

The reactive diluent of the first component may be the same as or different from the reactive diluent of the second component. One or more reactive diluents, such as 2, 3, 4, 5, 6, 7, 8, 9, 10 or more reactive diluents, shall be used in the second component. Independently of this, at least one reactive diluent, such as 2, 3, 4, 5, 6, 7, 8, 9, 10 or more reactive diluents, shall preferably be used in the second component. As mentioned above, the reactive diluents of the first component and the second component are selected independently of each other, but where there is a multiplicity of reactive diluents in one component, preferably only epoxide functional reactive diluents are used. It is excluded that the homopolymerization catalyst already causes polymerization of the reactive diluent or the reactive diluents of the second component. An epoxide resin can also be used as a reactive diluent.

According to another embodiment the homopolymerization catalyst is selected from the group consisting of Lewis acids, Lewis bases and combination thereof.

As mentioned above, the homopolymerization catalyst is present only in the second component. A mixture of different homopolymerization catalysts, such as 2, 3, 4, 5 or more homopolymerization catalysts, can be used. The homopolymerization catalyst preferably only catalyzes the reaction of epoxide groups. Optionally, the reaction of an epoxide group with a hydroxyl group or the reaction of an epoxide group with an amino group can also be catalyzed. The catalyst has no cross linking activity. As a result, compounds such as polyfunctional amines, which can catalyze homopolymerization catalysis both as Lewis bases and through the presence of several amino functionalities, do not represent homopolymerization catalysts in the sense of the present invention. The same applies, for example, to acid anhydrides, which participate in the cross linking of molecules in addition to the catalytic reaction. In other words, these two components in the proper sense, do not represent catalysts, since they participate in the reaction and are bound in covalent form in the epoxide resin system.

Lewis acids for the purpose of this application are electron pair acceptors and consist primarily of partial salts or salts of semi-metals. Examples of suitable Lewis acids include titaniumtetrachloride, boron trihalide, boric acid, trialkylborane and aluminum trihalide. Examples of boron trihalide include BF₃, BCl₃ und BBr₃. Examples of aluminum trihalide include AlF₃, AlCl₃ und AlBr₃. Examples of suitable trialkylboranes include trialkylboranes having the same or different alkyl residues, where the molecular weight of the trialkylboranes is not exceeding 650 g/mol, preferably 600 g/mol, 500 g/mol, 400 g/mol, or 300 g/mol. Preferred trialkylboranes are trimethylborane, triethylborane, tri-n-propylborane and trichloro(N,N-dimethyloctylamin)borane. Trichlor(N,N-dimethyloctylamine)boron is particularly preferred.

By contrast, Lewis bases are electron pair donors and therefore comprise at least one free electron pair. Suitable examples of Lewis bases include, for example, trimethylamine. Polyfunctional amines and acid anhydrides are excluded since they are also involved in the reaction with epoxide groups in addition to the catalysis of the reaction of epoxide groups. Examples of suitable Lewis bases include R₂NH and R₃N. The residues R of the components R₂NH, R₃N may be identical or different, comprise linear or branched alkyl, alkylene and alkynyl residues and comprise a molecular weight of the compound which is 650 g/mol, preferably 600 g/mol, 500 g/mol, 400 g/mol, or 300 g/mol. Trimethylamine is preferred.

A Lewis base having an acid strength according to the HSAB principle is preferably used as homopolymerization catalyst, wherein the acid strength corresponds at least to that of a compound of the type BX₃(NR)₃. Alternatively, a Lewis base with a base strength according to the HSAB principle is used as homopolymerization catalyst, wherein the base strength corresponds at least to that of a compound of the type NH(R)₂. X can be a halide, for example fluorine, chlorine, bromine or iodine. X is preferably fluorine or chlorine. It is clear that different residues X may be present in the compound of the type BX₃(NR)₃. The afore-mentioned R residues of the compounds may be identical or different, comprise linear or branched alkyl, alkylene and alykynyl residues and comprise a molecular weight of the compound not exceeding 650 g/mol, preferably 600 g/mol, 500 g/mol, 400 g/mol or 300 g/mol.

According to a further embodiment, the first component and/or second component comprises an ingredient selected from the group consisting of a thermally conductive particle, filler, dye and combinations thereof. It is clear that other ingredients may be present. It is also clear that the thermally conductive particle, filler, dye or other ingredient is not a homopolymerization catalyst, reactive diluent, epoxide resin or epoxide of the invention.

In a further embodiment, the first component comprises 30 to 40 wt.-% of epoxide resin, 5 to 10 wt.-% of reactive diluent, 40 to 60 wt.-% fillers and 0.5 to 1.5 wt.-% of pigment paste based on 100 wt.-% total weight of the first component.

In a further embodiment the second component comprises 70 to 90 wt.-% of reactive diluent and 10 to 30 wt.-% of homopolymerization catalyst based on 100 wt.-% total weight of the second component.

According to a further embodiment, between 80 and 98 wt.-% of the first component and 2 to 20 wt.-% of the second component are contained in the heat-curing two-component epoxide resin system based on 100 wt.-% total weight of the heat-curing two-component epoxide resin system. Preferably 85 to 95 wt.-% of the first component and 5 to 15 wt.-% of the second component are contained. More preferably between 90 and 95 wt.-% of the first component and 5 to 10 wt.-% of the second component are contained. The heat-curing two-component epoxide resin system according to the invention may contain, for example, 100 wt.-% of the first component and 10 wt.-% of the second component based on 110 wt.-% total weight of the heat-curing epoxide resin system.

It is clear that volume, viscosity and other properties of the first component and/or the second component are significantly influenced by the choice of the reactive diluent and its amount, and/or optional ingredients, as well as their amounts. As a result, not only the physical or chemical properties of the individual components but also the chemical or physical properties of the second component and the cured epoxide resin system can be influenced in a targeted manner. The chemical and physical properties of the heat-curing two-component epoxide resin according to the invention can be controlled by selectively influencing the mixing ratios of the first and second components and/or their respective components/constituents.

According to a preferred embodiment, the first component can be stored at a temperature of 15 to 25° C. for a time period of 6 months or longer, preferably at least 8 months, at least 10 months, more preferably at least 12 months.

According to a preferred embodiment, the second component can be stored at a temperature of 15 to 25° C. for a time period of 3 months or longer, preferably at least 4 months, at least 5 months, more preferably at least 6 months.

The storage of the first or second component for the above-mentioned time periods does not result in any measurable deterioration in the quality of the cured epoxide resin system compared to a corresponding epoxide resin system produced by direct mixing of the two components.

According to a preferred embodiment, the viscosity of the first component at a temperature of 22° C. is 20,000-100,000 mPa·s, preferably 30,000-90,000 mPa·s, 40,000-80,000 mPa·s, 50,000-75,000 mPa·s, more preferably bevorzugt 60,000-70,000 mPa·s. The viscosity can be determined with a viscometer, e.g. Haake Viskotester T550E100, e.g. at level 4.

According to a preferred embodiment, the viscosity of the second component at a temperature of 22° C. is 100-5,000 mPa·s, preferably 110-1,000 mPa·s, 120-500 mPa·s, 130-400 mPa·s, 140-300 mPa·s, more preferably 150-250 mPa·s. The viscosity can be determined with a viscometer, e.g. Haake Viskotester T550E100, e.g. at level 8.

According to a preferred embodiment, viscosity of the epoxide resin system mixed with a second component at a temperature of 22° C. is 5,000-15,000 mPa·s, preferably 6,000-12,000 mPa·s, 7,000-11,000 mPa·s, more preferably 8,000-10,000 mPa·s. The viscosity can be determined with a viscometer, e.g. Haake Viskotester T550E100.

According to a preferred embodiment, the density of the first component is 1.60-1.90 g/cm³, preferably 1.65-1.85 g/cm³, 1.70-1.80 g/cm³, more preferably 1.72-1.76 g/cm³. The density can be determined with a pyknometer, e.g. Elcometer 50 ml stainless steel.

According to a preferred embodiment, the density of the second component is 0.90-1.15 g/cm³, preferably 0.95-0.1 g/cm³, 1.00-1.06 g/cm³, more preferably 1.01-1.05 g/cm³. The density can be determined with a pyknometer, e.g. Elcometer 50 ml stainless steel.

According to a preferred embodiment, the Shore D hardness of the cured epoxide resin system is 70-90, preferably 72-88, 74-86, 76-84, more preferably 78-82. The Shore D hardness can be determined by ISO 868 or DIN 53505.

According to a preferred embodiment, the heat-curing two-component epoxide resin system is used as a sealing resin, fiber composite component, i.e. a component in composites, as corrosion protection or adhesive.

The respective configuration as sealing resin, fiber composite component, corrosion protection or adhesive determines the chemical and physical properties of the epoxide resin system, such as its viscosity, or other properties. The respective configurations, in particular properties and ingredients, are familiar to the skilled person.

According to another preferred embodiment of the present invention a mixture for a heat-curing two-component epoxide resin system is provided comprising a homopolymerization catalyst and a reactive diluent.

The homopolymerization catalyst and the reactive diluent are as mentioned above. In particular, the reactive diluent may be an epoxide resin. Similarly, the above quantities may be used for a homopolymerization catalyst and reactive diluent. For example, 10 to 30 wt.-% of homopolymerization catalyst and 70 to 90 Gew.-% of reactive diluent may be contained.

The invention is illustrated below using examples and explained in more detail in the following description.

### EXAMPLES

The products mentioned in the examples WEVOPDX VP GE 7314/6-3, WEVODUR VP GE 7314/6-3, WEVOPDX VP GE 06-2012/4-6 and WEVODUR VP GE 06-2012/4-6 are commercially available from WEVO-CHEMIE GmbH, Ostfildern-Kemnat, Germany.

### Example 1

A mineral-filled electro sealing resin based on epoxide resins is provided. The resin component contains mineral fillers. Halogenated flame retardants or acid anhydrides as hardness components are not included. 100 wt.-% of WEVOPDX VP GE 7314/6-3 (resin component or first component, respectively) are successively heated to 80° C. with 10 wt.-% WEVODUR VP GE 7314/6-3 (second component with homopolymerization catalyst and reactive diluent) to reduce the viscosity of the resin component and then mixed. The mixture can be used directly as a sealing compound. The electrical properties of the final epoxide resin system can be improved by degassing the two components at 1 to 5 mbar beforehand. 250 g of the epoxide resin system according to the invention are produced.

The components comprise the following properties:

| | | | |
|---|---|---|---|
| Viscosity (22° C.): | WEVOPOX VP GE 7314/6-3 | 50.000-60.000 | mPa · s |
| | WEVODUR VP GE 7314/6-3 | 150-250 | mPa · s |
| | resin/catalyst mixture at 22° C.: | 8000-10.000 | mPa · s |
| Density (22° C.): | WEVOPOX VP GE 7314/6-3 | 1.72-1.76 | g/cm³ |
| | WEVODUR VP GE 7314/6-3 | 1.01-1.05 | g/cm³ |

| Color: | WEVOPOX VP GE 7314/6-3 | | black or yellowish |
|---|---|---|---|
| | WEVODUR VP GE 7314/6-3 | | as desired |
| Processing time | approx. 30 Min | | at 120° C. |
| (250 g batch): | | | |
| Minimum curing time: | 2 hours at 80° C. + | | |
| | 3 hours at 120° C. | | |
| | | | Test specifications |
| Data of molding material | | | |
| Shore hardness D: | 78-82 | | ISO 868, DIN 53505 |
| Thermal conductivity: | — | | DIN 22007-2/2008 |
| Glass transition | approx. 64° C. | | TMA |
| temperature: | (4 h/120° C.) | | |
| Flame properties: | — | | — |
| Linear coefficient of | 84 | ppm/K | <60° C., TMA |
| thermal expansion: | 144 | ppm/K | >70° C., TMA |
| Elec. properties | | | |
| Dielectric strength: | 30 | kV/mm | DIN IEC 60244-6 |
| | | | VDE 0303, TI.2 |
| Surface resistance: | 10¹⁵ | Ω | DIN IEC 60093 |

| | | |
|---|---|---|
| | | VDE 0303, TI.30 |
| Tracking resistance: | CTI 600 | DIN IEC 60112 |
| | | VDE 0303, TI.1 |

| | |
|---|---|
| Delivery form: | 30 kg packages and 250 kg barrel |
| Durability: | In closed original package, at dry storage at 15° C. |
| | to 25° C., the first component at least 12 months |
| | and the second component at least 6 months |

### Example 2

The properties of the heat-curing two-component epoxide resin system according to the invention from 100 wt.-% of WEVOPDX VP GE 7314/6-3 and 10 wt.-% of WEVODUR VP GE 7314/6-3 according to Example 1 are compared with those of a conventional epoxide resin system. The conventional epoxide resin system consisting of 100 wt.-% of WEVOPDX VP GE 06-2012/4-6 (epoxide resin-containing component) and 24 wt.-% of WEVODUR VP GE 06-2012/4-6 (acid anhydride-containing component) is also a two-component system where an acid anhydride is used as curing agent (comparison example).

The cured system according to the invention of WEVOPDX VP GE 7314/6-3 and WEVODUR VP GE 7314/6-3 is designated GE 7314/6-3, whereas the cured system of WEVOPDX VP GE 06-2012/4-6 and WEVODUR VP GE 06-2012/4-6 is designated GE 06-2012/4-6.

The viscosity is determined with a Haake Viskotester T550E100, the density with an Elecometer 50 ml stainless steel, the pot life with a Haake Viskotester T550E100 (measurement of the viscosity increase to 8000 mPas at 179.6 l/min at 110° C.) and the glass transition temperature or thermal expansion coefficient with a TMA, Seiko Exstar SS6000.

Table 1 shows that the relevant properties of the final epoxide resin systems, such as polymerization or curing temperature and time, density, Shore D hardness, etc., largely coincide.

TABLE 1

| | | GE 7314/6-3 |
|---|---|---|
| | | (epoxide resin |
| | GE 06-2012/4-6 | system according |
| | (comparative exa.) | to Example 1) |
| Remark | heat-curing | heat-curing |
| Properties UL94 V | no | no |
| Polymerization | 2 h/100° C. + | 2 h/100° C. + |
| | 2 h/120° C. | 2 h/120° C. |
| Viscosity T550E100 level 4 | 35,000 | 57,000 |
| 22° C., [mPa*s] | | |
| Viscosity VT550E100 level 8 | 50-100 | 150-250 |
| 22° C., [mPa*s] | | |
| Density, pyknometer [g/cm³] | 1.76 | 1.74 |
| Shore D 16 h/80° C. | 81 | 80 |
| Mixture ratio | 100:24 | 100:10 |
| Pot life 100 g resin + | 35 Min/110° C. | 50 Min/110° C. |
| xg hardener in 1/10 dose | | |
| VT550E100 level 8 to RT | | |
| Mixture viscosity | 2270 | 9000 |
| VT550E100 level 8 RT | | |
| Thermal class | F-class/155° C. | F-class/155° C. |
| Glass transition temperature | 58° C. | 64° C. |
| (Tg. 4 h/120° C.) | | |
| Coefficient of thermal | 144 | 144 |
| expansion (CTE) over Tg. | | |
| CTE under Tg. | 50 | 84 |

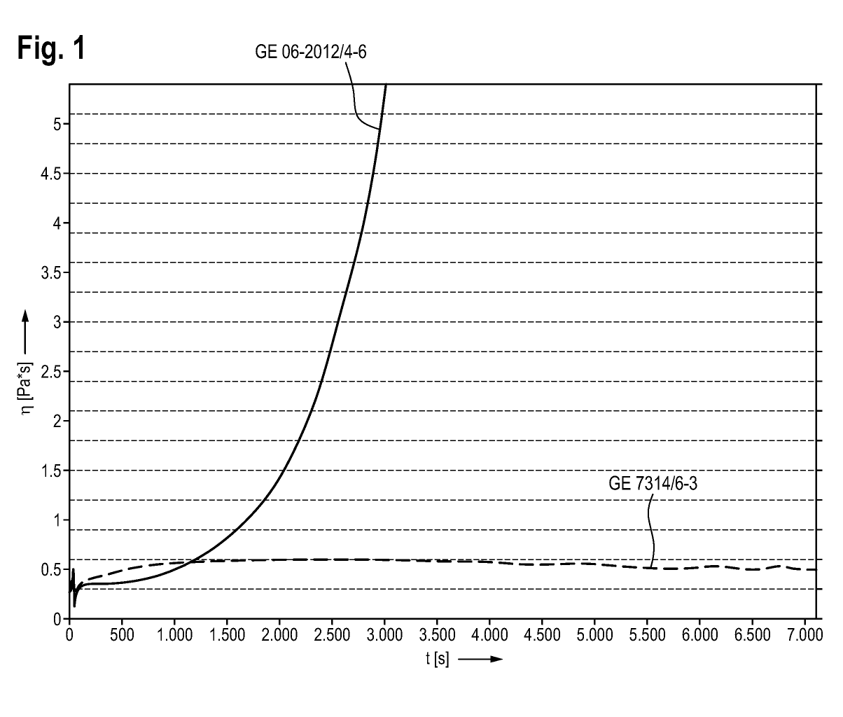

FIG. 1 also shows that although the epoxide resin system without acid anhydride has a higher mixing viscosity at room temperature than the epoxide resin system according to the invention, this effect is no longer significant at higher processing temperatures. This is also shown in Table 2 below.

TABLE 2

| | | GE 7314/6-3 |
|---|---|---|
| | | (epoxide resin |
| | GE 06-2012/4-6 | system according |
| | (comparative exa.) | to Example 1) |
| Viscosity (RT, mPas) | 34,500 | 56,900 |
| Density (g/cm³) | 1.77 | 1.74 |
| Mixing viscosity (mPas) | 1,650 | 9,000 |
| Mixing visc. | 375 | 450 |
| (80° C., mPas) - 5 min | | |
| Mixing ratio | 620 | 550 |
| (80° C., mPas) - 20 min | | |
| Mixing visc. | 5,000 | 600 |
| (80° C., mPas) - 50 min | | |
| Mixing ratio | 100:24 | 100:10 |

The epoxide resin system of the present invention thus exhibits similar properties with regard to processing, mechanical and physical data compared to an epoxide resin system cured with acid anhydride.

The heat-curing two-component epoxide resin system according to the invention has a number of advantages over the epoxide resin systems known in the state of the art. Both components of the epoxide resin system according to the invention can be used in variable mixing ratios over a wide range. By the selection and quantity of the reactive diluent in the second component, as well as the epoxide resin in the first component, the mechanical properties of the components and those of the final epoxide resin system can be varied and adjusted as desired. The reactivity and thus the time to complete polymerization, can also be adjusted via the proportion of the catalyst in the second component. Similarly, fillers such as quartz flour or aluminumtrihydoxide can be used in the epoxide resin system to obtain flame retardant or improved electrical properties. In addition, the use of fillers can reduce shrinkage and heat generation during the exothermic polymerization reaction. The physiological advantage of acid anhydride-free systems is evident as there are no respiratory sensitizing acid anhydrides. A further advantage is the lower moisture sensitivity of the acid anhydride-free epoxide resin system and the associated higher storage stability.

What is claimed is:

1. A heat-curing two-component epoxide resin system comprising:
a first component comprising an epoxide resin; and
a second component being separately present from the first component,
wherein the second component comprises a homopolymerization catalyst and a reactive diluent.

2. The heat-curing two-component epoxide resin system of claim 1, wherein the epoxide resin is selected from the group consisting of: a bisphenol-based epoxide resin, a novolac epoxide resin, an aliphatic epoxide resin, a halogenated epoxide resin, and combinations thereof.

3. The heat-curing two-component epoxide resin system of claim 1, wherein the first component comprises a reactive diluent.

4. The heat-curing two-component epoxide resin system of claim 1, wherein the reactive diluent of the first component or the reactive diluent of the second component or both are selected from the group consisting of: glycidyl ethers and combinations thereof.

5. The heat-curing two-component epoxide resin system of claim 1, wherein the homopolymerization catalyst is selected from the group consisting of: Lewis acids and Lewis bases and combinations thereof.

6. The heat-curing two-component epoxide resin system of claim 1, wherein the first component or the second component comprise an ingredient selected from the group consisting of: a thermally conductive particle, filler, dye, and combinations thereof.

7. The heat-curing two-component epoxide resin system of claim 1, wherein the first component comprises 30-40 wt.-% of epoxide resin, 5-10 wt.-% of reactive diluent, 40-60 wt.-% of fillers and 0.5-1.5 wt.-% of pigment paste based on 100 wt.-% total weight of the first component.

8. The heat-curing two-component epoxide resin system of claim 1, wherein the second component comprises 70-90 wt.-% of reactive diluent and 10-30% wt.-% of homopolymerization catalyst based on 100 wt.-% total weight of the second component.

9. The heat-curing two-component epoxide resin system of claim 1, containing 80 to 98 wt.-% of the first component and 2 to 20 wt.-% of the second component.

10. A mixture for a heat-curing two-component epoxide resin system comprising:
a homopolymerization catalyst, and
a reactive diluent.

11. The mixture for a heat-curing two-component epoxide resin system of claim 10, containing 10-30% wt.-% of homopolymerization catalyst and 70-90 wt.-% of reactive diluent.
